(19) United States
(12) Patent Application Publication
(10) Pub. No.: US 2023/0037089 A1
(43) Pub. Date: Feb. 2, 2023

(54) OPERATION CONTROL METHOD AND APPARATUS, STORAGE MEDIUM, AND ELECTRONIC DEVICE

(71) Applicant: Tencent Technology (Shenzhen) Company Limited, Shenzhen (CN)

(72) Inventors: Ying DENG, Shenzhen (CN); Jiaqi PAN, Shenzhen (CN); Ke MAO, Shenzhen (CN); Xiaoqing WEN, Shenzhen (CN); Weixiang YU, Shenzhen (CN); Jing KOU, Shenzhen (CN); Zefeng YANG, Shenzhen (CN)

(73) Assignee: Tencent Technology (Shenzhen) Company Limited, Shenzhen (CN)

(21) Appl. No.: 17/964,162

(22) Filed: Oct. 12, 2022

Related U.S. Application Data
(63) Continuation of application No. PCT/CN2021/126237, filed on Oct. 26, 2021.

(30) Foreign Application Priority Data
Nov. 30, 2020 (CN) 202011381093.9

(51) Int. Cl. A63F 13/58; A63F 13/56; G06T 19/20; G06T 17/00; G06T 13/40; G06F 3/04815

(52) U.S. Cl. CPC A63F 13/58; A63F 13/56; G06T 19/20; G06T 17/00; G06T 13/40; G06F 3/04815; A63F 2300/1075

(57) ABSTRACT

An operation control method is provided. A virtual scene of a virtual character and a movement control interface are displayed. The movement control interface is configured to receive a movement control operation to control movement of the virtual character in the virtual scene. A switch configuration interface is displayed in response to a switch configuration operation being performed on the movement control interface. The switch configuration interface is configured to receive a switch attribute configuration control operation for the virtual character. Target attribute configuration information for the virtual character is determined in response to the switch attribute configuration control operation being performed on the switch configuration interface. Further, the virtual character is controlled based on the target attribute configuration information.

### RELATED APPLICATIONS

The present application is a continuation of International Application No. PCT/CN2021/126237, entitled “OPERATION CONTROL METHOD AND APPARATUS, STORAGE MEDIUM, AND ELECTRONIC DEVICE” and filed on Oct. 26, 2021, which claims priority to Chinese Patent Application No. 202011381093.9, entitled “OPERATION CONTROL METHOD AND APPARATUS, STORAGE MEDIUM, AND ELECTRONIC DEVICE” and filed on Nov. 30, 2020. The entire disclosures of the prior applications are hereby incorporated by reference in their entirety.

### FIELD OF THE TECHNOLOGY

This application relates to the field of computers, including to an operation control technology for a terminal device.

### BACKGROUND OF THE DISCLOSURE

In many mobile game clients, a player usually needs to rely on both hands to perform touch screen operations or key operations, to control virtual objects in the game. Most operations are completed by the right hand. In an actual scene, when multiple control operations need to be performed quickly, the player needs to use the right hand to quickly switch among the multiple control operations in a short time. This not only greatly increases the operation load of the right hand, but also can make it difficult to achieve a desired control effect due to a switching delay between some of the control operations among the multiple control operations, resulting in low operation efficiency.

In view of the problems, no effective solution has been provided yet.

### SUMMARY

Embodiments of this disclosure include an operation control method and apparatus, a non-transitory computer-readable storage medium, and an electronic device. In an example, the embodiments can help a user to improve operation efficiency when quickly switching among multiple control operations.

According to an aspect of the embodiments of this disclosure, an operation control method provided. A virtual scene of a virtual character and a movement control interface are displayed. The movement control interface is configured to receive a movement control operation to control movement of the virtual character in the virtual scene. A switch configuration interface is displayed in response to a switch configuration operation being performed on the movement control interface. The switch configuration interface is configured to receive a switch attribute configuration control operation for the virtual character. Target attribute configuration information for the virtual character is determined in response to the switch attribute configuration control operation being performed on the switch configuration interface. Further, the virtual character is controlled based on the target attribute configuration information.

According to another aspect of the embodiments of this disclosure, an information processing apparatus, including processing circuitry, is further provided. The processing circuitry is configured to display (i) a virtual scene of a virtual character and (ii) a movement control interface. The movement control interface is configured to receive a movement control operation to control movement of the virtual character in the virtual scene. The processing circuitry is configured to display a switch configuration interface in response to a switch configuration operation being performed on the movement control interface. The switch configuration interface is configured to receive a switch attribute configuration control operation for the virtual character. The processing circuitry is configured to determine target attribute configuration information for the virtual character in response to the switch attribute configuration control operation being performed on the switch configuration interface. Further, the processing circuitry is configured to control the virtual character based on the target attribute configuration information.

According to still another aspect of the embodiments of this disclosure, a non-transitory computer-readable storage medium is further provided. The non-transitory computer-readable storage medium stores instructions which when executed by a processor cause the processor perform the operation control method.

According to still another aspect of the embodiments of this disclosure, an electronic device is further provided. The electronic device includes a memory and a processor, the memory storing a computer program, and the processor being configured to perform the operation control method through the computer program.

According to yet another aspect of the embodiments of this disclosure, a computer program product is further provided, the computer program product, when run on a computer, causing the computer to perform the operation control method.

In the embodiments of this disclosure, a virtual scene picture of a controlled virtual character performing a game task is displayed through a game application client, the virtual scene picture corresponding to a virtual scene of the game task; a switch configuration area corresponding to the virtual character is triggered to be displayed, in response to a first control operation performed on a movement control area in the virtual scene picture, the movement control area being configured to receive an operation of controlling the virtual character to move in the virtual scene, and the switch configuration area being configured to receive an operation of switching attribute configuration information for the virtual character; target attribute configuration information configured for the virtual character is determined in response to a second control operation performed on the switch configuration area; and the virtual character is controlled to perform the game task based on the target attribute configuration information. Through the first control operation performed in the movement control area, the switch configuration area corresponding to the virtual character is triggered to be displayed, and in combination with the second control operation performed in the switch configuration area, the target attribute configuration information configured for the virtual character is determined, thereby controlling the virtual character to perform the game task based on the target attribute configuration information. In this way, it can be beneficial for a player to quickly switch among multiple control operations in a short time during the game, the operation load of the right hand of the player can be reduced to some degree, and the switching delay in some of the control operations can be avoided, thereby improving the control efficiency and addressing, for example, the technical problem of low operation efficiency due to the difficulty of the player in quickly switching among the multiple control operations in a short time during the control of the game process.

### BRIEF DESCRIPTION OF THE DRAWINGS

FIG. 1 is a schematic diagram of an application environment of an operation control method according to an embodiment of this disclosure;

FIG. 2 is a schematic diagram of an application environment of another operation control method according to an embodiment of this disclosure;

FIG. 3 is a schematic flowchart of an operation control method according to an embodiment of this disclosure;

FIG. 4 is a schematic diagram of display of a terminal interface of an operation control method according to an embodiment of this disclosure;

FIG. 5 is a schematic diagram of display of a terminal interface of another operation control method according to an embodiment of this disclosure;

FIG. 6 is a schematic diagram of display of a terminal interface of still another operation control method according to an embodiment of this disclosure;

FIG. 7 is a schematic diagram of display of a terminal interface of yet another operation control method according to an embodiment of this disclosure;

FIG. 8 is a schematic diagram of display of a terminal interface of still another operation control method according to an embodiment of this disclosure;

FIG. 9 is a schematic diagram of display of a terminal interface of still another operation control method according to an embodiment of this disclosure;

FIG. 10 is a schematic diagram of a touch operation detection of still another operation control method according to an embodiment of this disclosure;

FIG. 11 is a schematic flowchart of another operation control method according to an embodiment of this disclosure;

FIG. 12 is a schematic structural diagram of an operation control apparatus according to an embodiment of this disclosure; and

FIG. 13 is a schematic structural diagram of an electronic device according to an embodiment of this disclosure.

### DESCRIPTION OF EMBODIMENTS

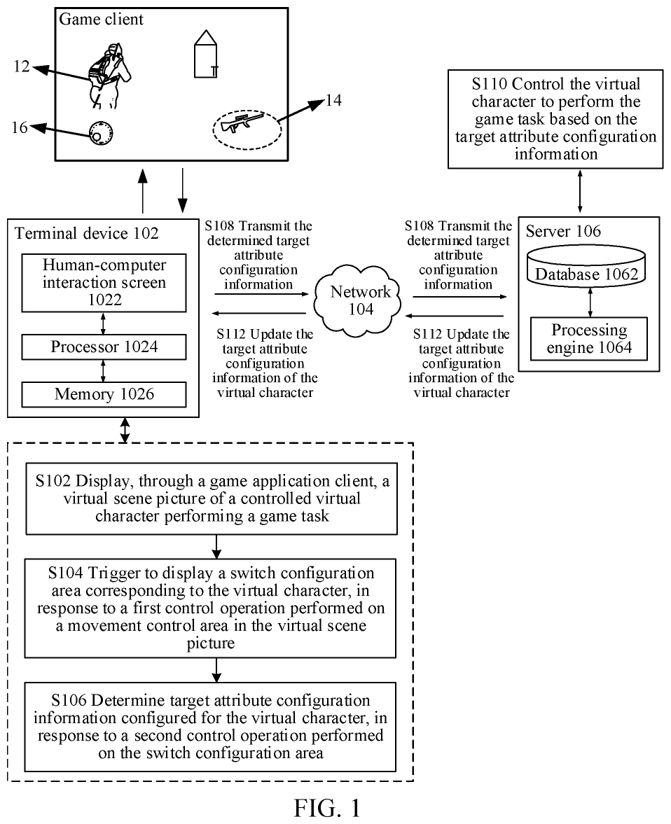

Embodiments of this disclosure includes an operation control method. As an exemplary implementation, the operation control method may be applied to, but is not limited to, an environment shown in FIG. 1.

The hardware environment includes: a terminal device 102 that performs human-computer interaction with a user, a network 104, and a server 106.

A game application client runs in the terminal device 102. The terminal device 102 includes a human-computer interaction screen 1022, processing circuitry such as a processor 1024, and a memory 1026. The human-computer interaction screen 1022 is configured to display a virtual scene in a game task run by the game application client, is further configured to provide a human-computer interaction port, to receive, through the human-computer interaction port, a human-computer interaction operation performed by a user through a human-computer interaction interface, and is further configured to display each virtual character in the virtual scene and an operation panel for controlling the virtual character to perform operations. The operation panel includes operation controls configured to trigger operations. The processor 1024 is configured to trigger to display a switch configuration area corresponding to the virtual character, in response to a first control operation performed on a movement control area in a virtual scene picture, and determine target attribute configuration information configured for the virtual character, in response to a second control operation performed on the switch configuration area. The memory 1026 is configured to store game task information of the virtual character and attribute configuration information of the virtual character. The attribute configuration information may include the target attribute configuration information of the virtual character selected by the current user.

The server 106 includes a database 1062 and a processing engine 1064. The database 1062 is configured to store the attribute configuration information and the game task information of each virtual object. The processing engine 1064 is configured to receive the target attribute configuration information of the virtual character transmitted by the terminal device 102, to control the virtual character to perform the game task based on the target attribute configuration information.

The specific process includes the following steps: It is assumed that a game application client runs in the terminal device 102 shown in FIG. 1, and a virtual scene picture provided by the game application client is displayed on the terminal device 102. A game player may control, through a movement control area 16, a first virtual character 12 to perform a game operation. Attribute configuration information of the first virtual character 12 is updated through the following steps, such that the first virtual character 12 performs the game operation based on target attribute configuration information 14.

As described in steps S102-S106, a virtual scene picture of a controlled virtual character performing a game task is displayed through a game application client; a switch configuration area corresponding to the virtual character is triggered to be displayed, in response to a first control operation performed on a movement control area in the virtual scene picture, the movement control area being configured to receive an operation of controlling the virtual character to move in the virtual scene, and the switch configuration area being configured to receive an operation of switching attribute configuration information for the virtual character; and target attribute configuration information configured for the virtual character is determined in response to a second control operation performed on the switch configuration area. Then step S108 is performed to transmit the determined target attribute configuration information to a server 106 through a network 104, such that the server 106 controls the virtual character to perform a game task based on the target attribute configuration information, as described in step S110. Further, step S112 is performed, in which the terminal device 102 is notified through the network 104, to complete updating the target attribute configuration information of the virtual character.

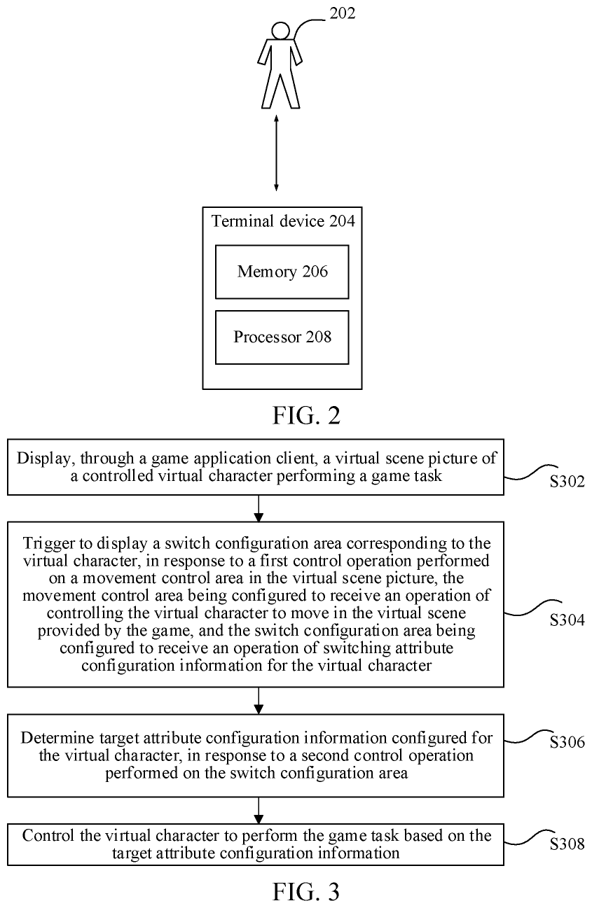

As another exemplary implementation, an operation control method provided in an embodiment of this disclosure may be applied to an environment shown in FIG. 2. As shown in FIG. 2, a user 202 may perform human-computer interaction with a terminal device 204. The terminal device 204 includes a memory 206 and processing circuitry such as a processor 208. The terminal device 204 in this embodiment may perform the operations performed by the terminal device 102 and other operations, to control the virtual character to perform the game task based on the target attribute configuration information.

In an example, the terminal device 102 and the terminal device 204 are terminal devices configured with a game application client, and may include, but are not limited to, at least one of the following: a mobile phone (for example, an Android mobile phone, or an iOS mobile phone), a notebook computer, a tablet computer, a palmtop computer, a mobile Internet device (MID), a PAD, a desktop computer, a smart TV, and the like. The network 104 may include, but is not limited to: a wired network and a wireless network. The wired network includes: a local area network, a metropolitan area network, and a wide area network. The wireless network includes: a Bluetooth, a Wi-Fi, and another network implementing wireless communication. The server 106 may be a single server or a server cluster that includes a plurality of servers, or a cloud server. The description is merely an example, and this is not limited in this embodiment.

As an exemplary implementation, as shown in FIG. 3, an operation control method provided in an embodiment of this disclosure may include the following steps:

In step S302, a virtual scene picture of a controlled virtual character performing a game task may be displayed through a game application client. The virtual scene picture corresponds to a virtual scene of the game task. In an example, (i) a virtual scene of a virtual character and (ii) a movement control interface are displayed. The movement control interface may be configured to receive a movement control operation to control movement of the virtual character in the virtual scene.

In step S304, display of a switch configuration area corresponding to the virtual character may be triggered, in response to a first control operation performed on a movement control area in the virtual scene picture. The movement control area may be configured to receive an operation of controlling the virtual character to move in the virtual scene, and the switch configuration area may be configured to receive an operation of switching attribute configuration information for the virtual character. In an example, a switch configuration interface is displayed in response to a switch configuration operation being performed on the movement control interface. The switch configuration interface may be configured to receive a switch attribute configuration control operation for the virtual character.

In step S306, target attribute configuration information configured for the virtual character may be determined, in response to a second control operation performed on the switch configuration area. In an example, target attribute configuration information for the virtual character is determined in response to the switch attribute configuration control operation being performed on the switch configuration interface.

In step S308, the virtual character may be controlled to perform the game task based on the target attribute configuration information. In an example, the virtual character may be controlled based on the target attribute configuration information.

In an example, the virtual scene in the application may be a virtual scene of the game task established by a client or a server. The virtual scene may include a plurality of virtual characters, and the plurality of virtual characters may be the virtual characters operated by a plurality of users, or may be non-player virtual characters. The game application client displays the virtual scene picture through a display interface. During the game, when a player controls a virtual character to perform a game task, a switch configuration area (for example, for changing a skill or skin) corresponding to the currently controlled virtual character may be triggered to be displayed through a long press or double-click operation in a movement control area (which may be a virtual joystick or a direction key), and then the player may select target attribute configuration information in the switch configuration area, to control the virtual character to perform the game task based on the target attribute configuration information.

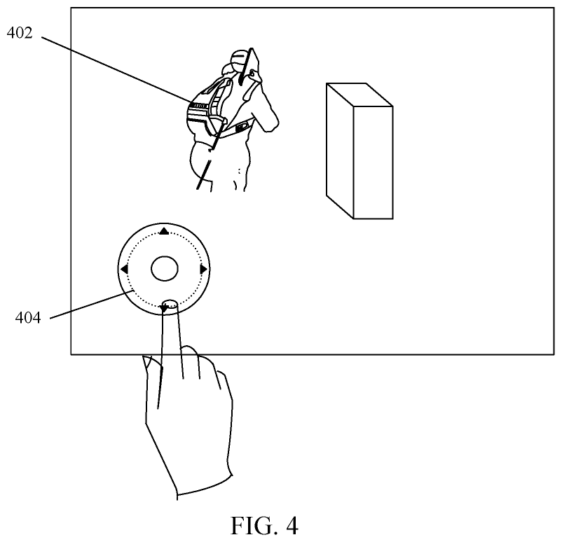

In step S302, a virtual scene picture of a controlled virtual character performing a game task is displayed through a game application client. Specifically, the virtual scene picture of the virtual character performing the game task is displayed on the game application client, which, for example, may be the following scene: the player controls the virtual character to enter an opponent camp for battle; as shown in FIG. 4, the player may control a virtual character 402 to perform the game task through a movement control area 404.

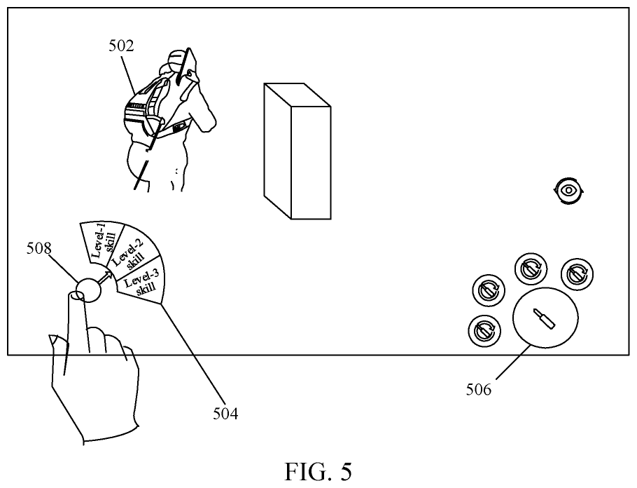

In step S304, the movement control area may include, but is not limited to, a virtual direction control or a virtual direction joystick configured to control movement of the virtual character in the game application client, which is not limited herein. The first control operation may include, but is not limited to, a long press or double-click operation performed by the player in the movement control area of the game application client. The switch configuration area may be configured to change skill configuration information or skin configuration information of the virtual character, or a panoramic image of the current game, which is not limited herein. For example, in the virtual scene picture shown in FIG. 5, the player may long press a virtual direction joystick 508 to trigger to display a switch configuration area 504, so as to provide skills configurable for a virtual character 502. For example, after the player selects a level-2 skill, corresponding target attribute configuration information 506 (to equip with weapon grenades) may be displayed at the lower right of the game application client.

In step S306, the second control operation may include, but is not limited to, a click selection or sliding selection operation performed by the player in the switch configuration area displayed on the game application client. That is, the player may select the target attribute configuration information configured for the virtual character in the switch configuration area by performing the click selection or the sliding selection operation. In this way, the operation difficulty due to that the player can only switch the attribute configuration information of the virtual character through the right hand is reduced to some extent, and the operation efficiency of the game is improved. As shown in FIG. 5, the player may select the target attribute configuration information 506 for the virtual character 502 by clicking a certain skill in the switch configuration area, or sliding from the virtual direction joystick 508 to a certain skill area.

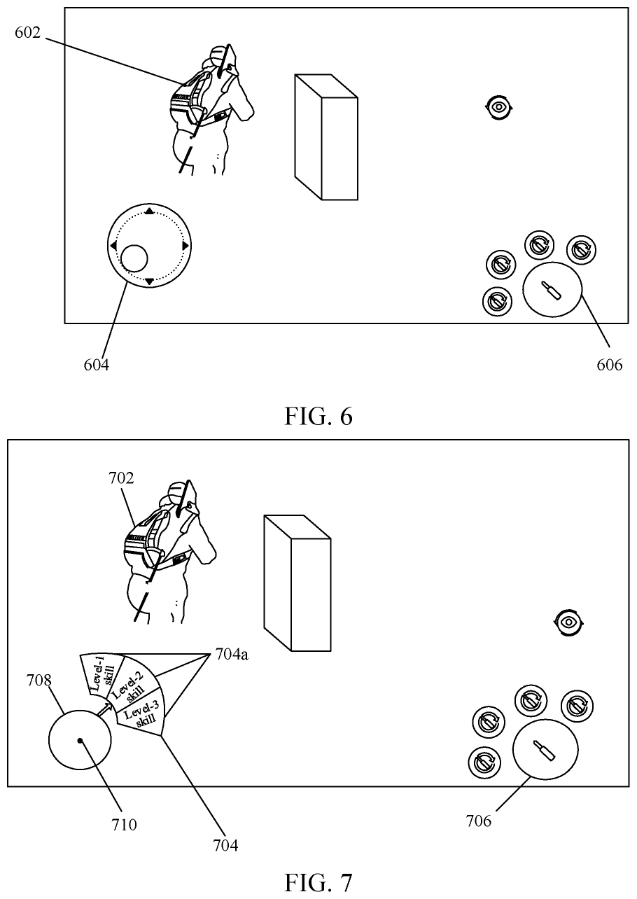

In step S308, the virtual character is controlled to perform the game task based on the target attribute configuration information. For example, the virtual character may be controlled to perform the game task based on the skill (such as using a selected gun or other weapons, or changing the current skin) selected by the player. As shown in FIG. 5, the player may select the target attribute configuration information 506 (to equip with weapon grenades) for the virtual character 502 by clicking the level-2 skill in the switch configuration area. As shown in FIG. 6, after a virtual character 602 is equipped with the target attribute configuration information 606, a movement control area 604 reverts to a normal operation state, and then the virtual character 602 may be controlled to complete the game task based on the equipped target attribute configuration information 606.

In the embodiment of this disclosure, through the first control operation performed in the movement control area, the switch configuration area corresponding to the virtual character is triggered to be displayed, and in combination with the second control operation performed in the switch configuration area, the target attribute configuration information configured for the virtual character is determined, thereby controlling the virtual character to perform the game task based on the target attribute configuration information. In this way, it may be beneficial for a player to quickly switch among multiple control operations in a short time during the game, the operation load of the right hand of the player can be reduced to some degree, and the switching delay in some of the control operations can be avoided, thereby improving the control efficiency.

In an embodiment, step S304 may include the following steps: displaying an operation layer in a target area associated with the movement control area, in response to the first control operation performed on the movement control area; and displaying at least one switch configuration subarea of the switch configuration area in the operation layer, where each switch configuration subarea corresponds to one type of candidate attribute configuration information.

As shown in FIG. 7, by double clicking a movement control area 708, the player may trigger a display operation layer in a target area associated with the movement control area. The operation layer displays three switch configuration subareas (or elements) 704a, which correspond to a level-1 skill, a level-2 skill, and a level-3 skill respectively. For example, candidate attribute configuration information 706 corresponding to the level-1 skill may be a weapon such as an axe or a knife, candidate attribute configuration information 706 corresponding to the level-2 skill may be a weapon such as a grenade or an antitank grenade, and candidate attribute configuration information 706 corresponding to the level-3 skill may be a weapon such as a rifle or a sniper gun. The player may configure the corresponding attribute configuration information for a virtual character 702 by selecting the corresponding switch configuration subarea. In this way, game controllability can be enhanced. Moreover, by displaying the switch configuration area in a manner of displaying the operation layer in the target area, there is no need to greatly modify the original display interface, which simplifies the display manner of the switch configuration area displayed based on the movement control area and ensures that the displayed switch configuration area is relatively intuitive. In addition, the player no longer controls the virtual character with the right hand only during the game, thus reducing the burden of the player and improving the user experience.

In an embodiment, the step of triggering to display an operation layer in a target area associated with a movement control area, in response to a first control operation performed on the movement control area may include any one of the following implementations: overlaying the operation layer on the movement control area, in a case that the target area is a part or all of the movement control area; in a case that the target area is a surrounding area of the movement control area, displaying the operation layer in the surrounding area, where the surrounding area is a concentric ring area corresponding to the movement control area, and a minimum display radius of the surrounding area is greater than or equal to a maximum display radius of the movement control area; and in a case that the target area is an adjacent area of the movement control area, displaying the operation layer in the adjacent area, where a distance between a center of the adjacent area and a center of the movement control area is less than a first threshold.

As shown in FIG. 7, in a case that the target area is a surrounding area 704 of the movement control area 708, the operation layer is displayed in the surrounding area, where the surrounding area 704 is a concentric ring area (the center of the circle is 710) corresponding to the movement control area 708, and a minimum display radius of the surrounding area 704 is greater than or equal to a maximum display radius of the movement control area.

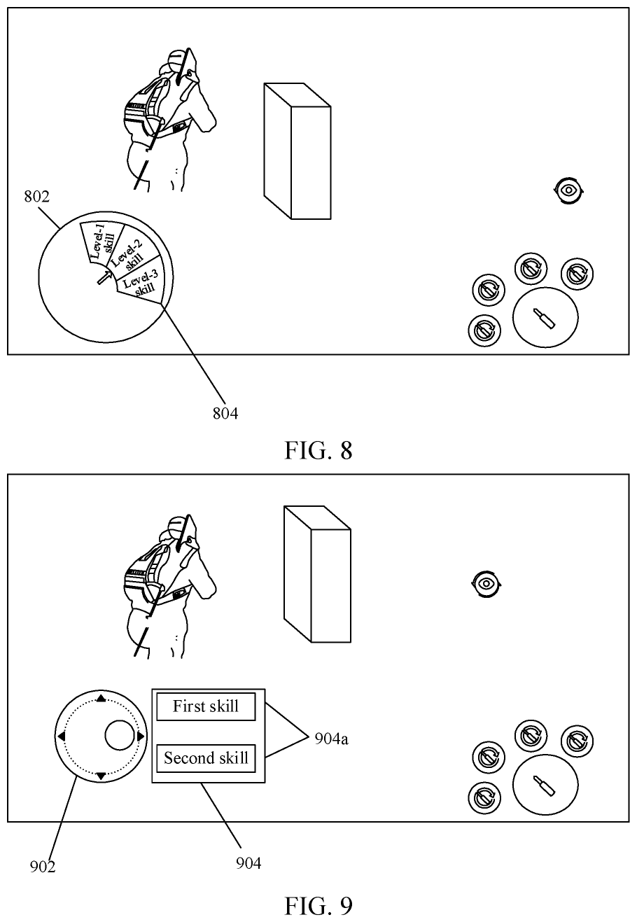

As shown in FIG. 8, an operation layer 804 is overlaid on a movement control area 802, in a case that the target area is a part or all of the movement control area 802.

As shown in FIG. 9, in a case that the target area is an adjacent area 904 of a movement control area 902, an operation layer 904a is displayed in the adjacent area 904, where a distance between a center of the adjacent area 904 and a center of the movement control area 902 is less than the first threshold. The first threshold may be a movement range implemented by the thumb of the left hand of the user based on the movement control area 902 when the user holds the terminal device, which is not limited herein.

The embodiments of this disclosure include a plurality of exemplary manners of displaying an operation layer. The operation layer is displayed based on the foregoing manners, which, on the one hand, can implement displaying a switch configuration area in an overlay manner and reduce the display difficulty of the switch configuration area without greatly modifying the original display interface. On the other hand, the foregoing display manners can display the switch configuration area intuitively, which may be beneficial for a player to better complete a configuration operation of attribute configuration information based on the switch configuration area, so that the player can flexibly update the attribute configuration information for a virtual character controlled in the game.

In an embodiment, the step of displaying at least one switch configuration subarea of a switch configuration area in an operation layer may include at least one of the following: displaying candidate skill configuration information corresponding to the virtual character in the switch configuration subarea; displaying candidate appearance configuration information corresponding to the virtual character in the switch configuration subarea; and displaying candidate prop configuration information corresponding to the virtual character in the switch configuration subarea.

The candidate skill configuration information corresponding to the virtual character displayed in the switch configuration subarea may be, for example, skill configuration information configured for the current virtual character, such as a flying skill or an earth hiding skill. The candidate appearance configuration information corresponding to the virtual character is displayed in the switch configuration subarea. The player may select favorite appearance configuration information in an equipment library of the selected virtual character, such as clothes, a skin color, and a hair style, which are not limited herein. The candidate prop configuration information corresponding to the virtual character is displayed in the switch configuration subarea. The player may select favorite prop configuration information in an equipment library of the selected virtual character, such as a gun, an axe, and an antitank grenade, which are not limited herein.

In addition, the switch configuration subarea may further provide a portal for the virtual character, that is, the virtual character may be transferred to a specific or designated place or space within a certain time through the portal in the switch configuration area. That is, a fast transmission tool may be provided through the switch configuration subarea.

The switch configuration subarea may further support switching a game map for the virtual character, and a current position of the virtual character in the game map may be located through the game map, which is convenient for the virtual character to determine a direction and position to go next.

The switch configuration subarea may further support providing the virtual character with a function of adding props for different teammates. A drop-down menu in the switch configuration subarea may be selected to select a target teammate, exchange props with the target teammate, or provide the prop of the player to the teammate. The switch configuration subarea may further support other shortcuts, which are not limited herein.

In the embodiments of this disclosure, the switch configuration area may carry at least one of the candidate skill configuration information, the candidate appearance configuration information, and the candidate prop configuration information, such that configuration information carried by the switch configuration area is more abundant, thereby making attribute information configuration supported by the switch configuration area more comprehensive.

In an embodiment, the step of determining target attribute configuration information configured for the virtual character, in response to a second control operation performed on the switch configuration area includes any one of the following: determining, in response to a click selection operation performed on a target switch configuration subarea in the switch configuration area, attribute configuration information corresponding to the target switch configuration subarea as the target attribute configuration information, where the second control operation includes the click selection operation; and determining, in response to a touch screen sliding selection operation performed on the target switch configuration subarea in the switch configuration area, the attribute configuration information corresponding to the target switch configuration subarea as the target attribute configuration information, where the second control operation includes the touch screen sliding selection operation.

As shown in FIG. 5, in response to a click selection operation performed on a target switch configuration subarea in the switch configuration area 504, attribute configuration information corresponding to the target switch configuration subarea is determined as the target attribute configuration information configured for the virtual character. In other words, a player may select the corresponding attribute configuration information as the target attribute configuration information of the virtual character by clicking any switch configuration subarea of the switch configuration area 504.

Alternatively, in response to the touch screen sliding selection operation performed on the target switch configuration subarea in the switch configuration area 504, attribute configuration information corresponding to the target switch configuration subarea in the switch configuration area 504 is determined as the target attribute configuration information. In other words, a player may select the corresponding attribute configuration information as the target attribute configuration information of the virtual character by sliding from a position of the virtual direction joystick 508 to any switch configuration subarea of the switch configuration area 504.

In this way, the embodiments of this disclosure provide two operation modes for switching attribute configuration information. The two operation modes are consistent with the game operation habits of a player, which can help improve the efficiency of switching the attribute configuration information, greatly simplify the operation complexity of the player in the game, and improve the user experience.

In an embodiment, the first control operation performed on the movement control area may be detected in any one of the following manners: determining that the first control operation is obtained, in a case that a press operation performed on the movement control area is detected and a press duration of the press operation reaches a target duration; and determining that the first control operation is obtained, in response to detecting a sliding operation according to a target track performed in the movement control area.

As shown in FIG. 4, it is determined that the first control operation is obtained in a case that a press operation performed by a player on the movement control area 404 is detected and a press duration of the press operation reaches a target duration. That is, the picture shown in FIG. 5 may be displayed, namely, the picture including the switch configuration area 504 and the target attribute configuration information 506 is displayed. Alternatively, in response to detecting a sliding operation performed by a player according to a target track in the movement control area, it is determined that the first control operation is obtained. The player may extract and set the target track in a game control option. For example, the player uses the virtual direction joystick 508 to perform a sliding operation of a predetermined track to trigger to display the switch configuration area, and the predetermined track may control the virtual direction joystick 508 to quickly move up and then quickly move down. The predetermined track may further control the virtual direction joystick 508 to quickly move leftward and then quickly move rightward.

The embodiments of this disclosure include two operation modes for triggering to display the switch configuration area. The two operation modes are consistent with the game operation habits of a player in practical application, which can help improve the displaying efficiency of the switch configuration area and reduce operation difficulty without affecting other operations of the player during the game. In addition, the player can flexibly update the attribute configuration information for the virtual character in the game the above different methods.

In an embodiment, the method provided in the embodiments of this disclosure may further include: skipping triggering to display the switch configuration area, in a case that the press operation performed on the movement control area is detected but the press duration of the press operation does not reach the target duration; or skipping triggering to display the switch configuration area in response to detecting that the sliding operation according to the target track is not completed in the movement control area.

A player may set the target duration as needed, thereby preventing erroneous operations from affecting the game process. Alternatively, the player may set the target track to be a track of moving up quickly and then moving down quickly in the game control options. During the game process of the user, when only a track part of moving up quickly appears, the switch configuration area is not triggered to be displayed, which can prevent erroneous operations from affecting the game process during.

Through the foregoing manner, erroneous operations in the game process can be reduced, thereby preventing erroneous operations from affecting the game process.

It should be noted that, for ease of description, the method embodiments are described as a series of action combinations. However, persons skilled in the art should know that the present disclosure is not limited to the described order of the actions because some steps may be performed in another order or performed at the same time according to the present disclosure. In addition, a person skilled in the art is also to learn that the embodiments described in this specification are all exemplary embodiments, and the involved actions and modules are not necessarily required to this disclosure.

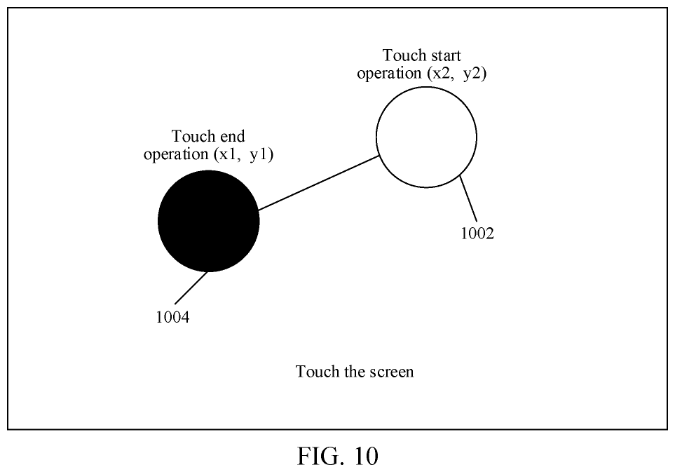

Based on the foregoing embodiments, in an embodiment, as shown in FIG. 10, in the foregoing operation control method, during the operation of the game application client, a long press operation performed on a joystick in a virtual scene picture is detected. The long press operation mainly includes three events: a touchstart operation event 1002 (touch start operate), a touchmove operation, and a touchend operation event 1004 (touch end operation). The most important attributes of the three events are pageX and pageY, where pageX represents a coordinate X of a touch target (a contact point between a finger of a user and a mobile device screen) in a device screen, and pageY represents a coordinate Y of the touch target (the contact point between the finger of the user and the mobile device screen) in the device screen.

The touchstart operation is an operation triggered when a user clicks a start control in the device screen, and the touchend operation is an operation triggered when the user chooses to end (that is, when the finger of the user leaves the mobile device screen) in the device screen.

After the touchstart operation event 1002 is activated, the touchmove operation is activated once. After the user performs the operation on the mobile device screen, a processor of the mobile device receives data of the touchstart operation event 1002, the touchmove operation event, and the touchend operation event 1004, and may determine that a gesture is a long press operation or a sliding operation. If a duration of the touchstart operation event 1002 reaches a preset value, it indicates that the user performs a long press operation on the mobile device screen. After receiving a processing result of the processor, a control unit performs a configuration operation of providing switch attribute configuration information for a virtual character. If coordinates (x1, y1) in the touchstart operation event 1002 are different from coordinates (x3, y3) of the touchmove operation event, it indicates that the user performs a sliding operation on the mobile device screen. Finally, an area of the attribute configuration information is determined according to coordinates (x2, y2) of the touchend operation event 1004. Target attribute configuration information is further equipped for the virtual character operated by the user.

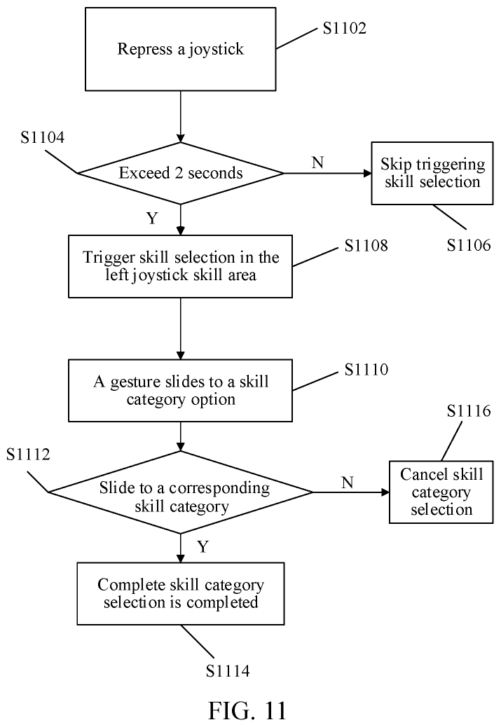

Based on the foregoing embodiments, in an embodiment, as shown in FIG. 11, the operation control method includes the following steps:

In step S1102: a repress operation performed on a virtual direction joystick on a device screen is detected, and then step S1104 is performed to determine whether a duration of the repress operation of the current user exceeds 2 seconds. If the duration does not exceed 2 seconds, step S1106 is performed to skip triggering skill selection (the target attribute configuration information is not displayed on the mobile device screen). If the duration exceeds 2 seconds, step S1108 is performed to trigger skill selection a left joystick skill area of the game application client on the device screen (that is, display the switch configuration area based on the movement control area). Then, S1110 is performed, in which a gesture slides to a skill category option (the current user touches the switch configuration area on the mobile device screen). Next, step S1112 is performed to determine whether the sliding reaches the corresponding skill category; if the sliding reaches the corresponding skill category (the current user touches a target attribute configuration information option in the switch configuration area on the mobile device screen), S1114 is performed to complete skill category selection (the current user determines the target attribute configuration information option in the switch configuration area). If the sliding does not reach the corresponding skill category (the current user does not select the target attribute configuration information option in the switch configuration area), S1116 is performed to cancel skill category selection (the current user cancels selection of the target attribute configuration information option in the switch configuration area).

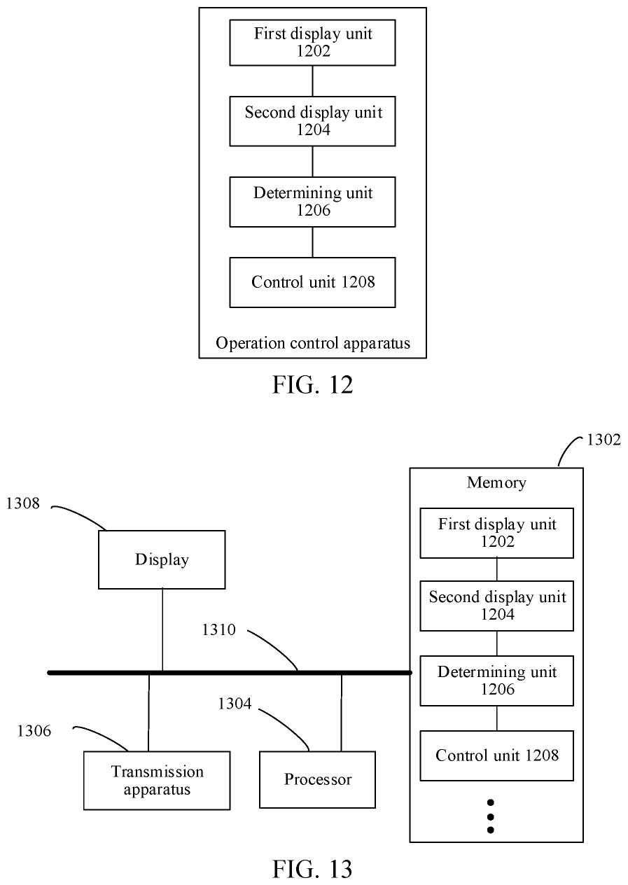

According to another aspect of the embodiments of this disclosure, an information processing apparatus such as an operation control apparatus for implementing the operation control method is further provided. One or more modules, submodules, and/or units of the apparatus can be implemented by processing circuitry, software, or a combination thereof, for example. As shown in FIG. 12, the apparatus may include a first display unit 1202, a second display unit 1204, a determining unit 1206, and a control unit 1208.

The first display unit 1202 is configured to display, through a game application client, a virtual scene picture of a controlled virtual character performing a game task, the virtual scene picture corresponding to a virtual scene of the game task.

The second display unit 1204 is configured to trigger to display a switch configuration area corresponding to a virtual character, in response to a first control operation performed on a movement control area in the virtual scene picture, the movement control area being configured to receive an operation of controlling the virtual character to move in the virtual scene, and the switch configuration area being configured to receive an operation of switching attribute configuration information for the virtual character.

The determining unit 1206 is configured to determine target attribute configuration information configured for the virtual character, in response to a second control operation performed on the switch configuration area.

The control unit 1208 is configured to control the virtual character to perform the game task based on the target attribute configuration information.

In an example, the second display unit 1204 is specifically configured to display an operation layer in a target area associated with the movement control area, in response to the first control operation performed on the movement control area; and display at least one switch configuration subarea of the switch configuration area in the operation layer; where each switch configuration subarea corresponds to one type of candidate attribute configuration information.

In an example, the second display unit 1204 is specifically configured to display the operation layer in any one of the following manners:

The second display unit 1204 may be configured to overlay the operation layer on the movement control area, in a case that the target area is a part or all of the movement control area.

The second display unit 1204 may be configured to display, in a case that the target area is a surrounding area of the movement control area, the operation layer in the surrounding area; where the surrounding area is a concentric ring area corresponding to the movement control area, and a minimum display radius of the surrounding area is greater than or equal to a maximum display radius of the movement control area.

The second display unit 1204 may be configured to display, in a case that the target area is an adjacent area of the movement control area, the operation layer in the adjacent area; where a distance between a center of the adjacent area and a center of the movement control area is less than a first threshold.

In an example, the second display unit 1204 is specifically configured to display the switch configuration area in at least one of the following manners:

The second display unit 1204 may be configured to display candidate skill configuration information corresponding to the virtual character in the switch configuration subarea.

The second display unit 1204 may be configured to display candidate appearance configuration information corresponding to the virtual character in the switch configuration subarea.

The second display unit 1204 may be configured to display candidate prop configuration information corresponding to the virtual character in the switch configuration subarea.

In an example, the determining unit 1206 is specifically configured to determine the target attribute configuration information in any one of the following manners:

The determining unit 1206 may be configured to determine, in response to a click selection operation performed on a target switch configuration subarea in the switch configuration area, attribute configuration information corresponding to the target switch configuration subarea as the target attribute configuration information.

The determining unit 1206 may be configured to determine, in response to a touch screen sliding selection operation performed on the target switch configuration subarea in the switch configuration area, attribute configuration information corresponding to the target switch configuration subarea as the target attribute configuration information.

In an example, the determining unit 1206 is further configured to skip triggering to display the switch configuration area, in a case that the press operation performed on the movement control area is detected but the press duration of the press operation does not reach a target duration; or skip triggering to display the switch configuration area, in response to detecting that the sliding operation according to the target track is not completed in the movement control area.

In an example, the first display unit 1202 is specifically configured to display the virtual scene picture of the virtual character performing the game task on the game application client.

In the embodiments of this disclosure, through the first control operation performed in the movement control area, the switch configuration area corresponding to the virtual character is triggered to be displayed, and in combination with the second control operation performed in the switch configuration area, the target attribute configuration information configured for the virtual character is determined, thereby controlling the virtual character to perform the game task based on the target attribute configuration information. In this way, it may be beneficial for a player to quickly switch among multiple control operations in a short time during the game, the operation load of the right hand of the player can be reduced to some degree, and the switching delay in some of the control operations can be avoided, thereby improving the control efficiency.

According to still another aspect of the embodiments of this disclosure, an electronic device for performing the operation control method is further provided. The electronic device may be a terminal device shown in FIG. 1. As shown in FIG. 13, the electronic device includes a memory 1302 and processing circuitry such as a processor 1304. The memory 1302 stores a computer program. The processor 1304 is configured to perform the steps in any one of the method embodiments by executing the computer program.

In an example, the electronic device may be located in at least one of a plurality of network devices in a computer network.

In an example, the processor may be configured to perform the operation control method in the embodiments through the computer program.

A person of ordinary skill in the art may understand that, the structure shown in FIG. 13 is only an example. Alternatively, the electronic device may be a smartphone (for example, an Android mobile phone or an iOS mobile phone), a tablet computer, a palmtop computer, a mobile Internet device (MID), a PAD or the like. FIG. 13 does not limit the structure of the electronic device. For example, the electronic device may further include more or fewer components (such as a network interface) than shown in FIG. 13, or have a configuration different from that shown in FIG. 13.

The memory 1302 may be configured to store a software program and a module, for example, a program instruction/module corresponding to the operation control method and apparatus in the embodiments of this disclosure, and the processor 1304 performs various functional applications and data processing by running a software program and a module stored in the memory 1302, that is, implementing the operation control method. The memory 1302 may include a high-speed RAM, and may further include a non-volatile memory such as one or more magnetic storage apparatuses, a flash memory, or another non-volatile solid-state memory. In some embodiments, the memory 1302 may further include memories remotely disposed relative to the processor 1304, and these remote memories may be connected to the terminal through a network. The examples of the network include, but are not limited to, the Internet, an intranet, a local area network, a mobile communication network, and a combination thereof. The memory 1302 may be specifically, but is not limited to being, configured to store the attribute configuration information and the game task of the virtual object. In an example, as shown in FIG. 13, the memory 1302 may include, but is not limited to, a first display unit 1202, a second display unit 1204, a determining unit 1206, and a control unit 1208 in the control operation apparatus. In addition, the memory may further include, but is not limited to, other module units in the operation control apparatus, and details are not described in this example again.

In an example, the transmission apparatus 1306 is configured to receive or transmit data through a network. Specific examples of the network include a wired network and a wireless network. In an example, the transmission apparatus 1306 includes a network interface controller (NIC). The NIC may be connected to another network device and a router by using a network cable, so as to communicate with the Internet or a local area network. In an example, the transmission apparatus 1306 is a radio frequency (RF) module, and is configured to wirelessly communicate with the Internet.

In addition, the electronic device may further include: a display 1308, configured to display the attribute configuration information of the virtual object; a connection bus 1310, configured to connect various module components in the electronic device.

In other embodiments, the terminal device or server may be a node in a distributed system. The distributed system may be a blockchain system. The blockchain system may be a distributed system formed by the plurality of nodes connected in the form of network communication. A peer to peer (P2P) network may be formed between the nodes. A computing device in any form, for example, an electronic device such as a server or a terminal, may become a node in the blockchain system by joining the P2P network.

According to still another aspect of the embodiments of this disclosure, a computer-readable storage medium is further provided. The computer-readable storage medium stores a computer program, the computer program being configured to perform steps in any one of the method embodiments when being run.

In an example, the computer-readable storage medium may be configured to store the operation control method configured to perform the embodiments.

A person of ordinary skill in the art may understand that all or some of the steps of the various methods in the embodiments may be implemented by a program instructing relevant hardware. The program may be stored in a computer-readable storage medium, such as a non-transitory computer-readable storage medium. The storage medium may include: a flash drive, a Read-Only Memory (ROM), a Random Access Memory (RAM), a magnetic disk, an optical disc, and the like.

The sequence numbers of the embodiments of this disclosure are merely for description purpose, and do not indicate the preference among the embodiments.

When the integrated unit in the embodiments is implemented in the form of a software function unit and sold or used as an independent product, the integrated unit may be stored in the computer-readable storage medium. Based on such an understanding, one or more technical solutions of this disclosure may be implemented in a form of a software product. The computer software product is stored in a storage medium and comprises several instructions for instructing one or more computer devices (which may be a PC, a server, a network device, or the like) to perform all or some of steps of the methods in the embodiments of this disclosure.

In the embodiments of this disclosure, the descriptions of the embodiments have respective focuses. For a part that is not described in detail in an embodiment, reference may be made to related descriptions in other embodiments.

In the several embodiments provided in this disclosure, it is to be understood that the disclosed client may be implemented in other manners. The described apparatus embodiments are merely exemplary. For example, the unit division is merely logical function division, and may use other division manners during actual implementation. For example, a plurality of units or components may be combined or integrated into another system, or some features may be omitted or not performed. In addition, the displayed or discussed mutual couplings or direct couplings or communication connections may be implemented through some interfaces. The indirect couplings or communication connections between the units or modules may be implemented in electronic or another form.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The units described as separate parts may or may not be physically separate, and components displayed as units may or may not be physical units, that is, may be located in one position, or may be distributed on a plurality of network units. Some or all of the units may be selected according to an actual requirement to achieve the objectives of the solutions in the embodiments.

In addition, functional units in the embodiments of this disclosure may be integrated into one processing unit, or each of the units may exist alone physically, or two or more units are integrated into one unit. The integrated unit may be implemented in the form of hardware, or may be implemented in the form of a software function unit.

It should be noted that the descriptions are merely exemplary embodiments of the present disclosure, and a person of ordinary skill in the art may make various improvements and modifications without departing from the spirit of the present disclosure. Other embodiments are within the scope of the present disclosure.

What is claimed is:

1. An operation control method, comprising:
displaying (i) a virtual scene of a virtual character and (ii) a movement control interface, the movement control interface being configured to receive a movement control operation to control movement of the virtual character in the virtual scene;
displaying, by processing circuitry, a switch configuration interface in response to a switch configuration operation being performed on the movement control interface, the switch configuration interface being configured to receive a switch attribute configuration control operation for the virtual character;
determining target attribute configuration information for the virtual character in response to the switch attribute configuration control operation being performed on the switch configuration interface; and
controlling the virtual character based on the target attribute configuration information.

2. The operation control method according to claim 1, wherein
the displaying the switch configuration interface includes displaying the switch configuration interface in a target area associated with the movement control interface in response to the switch configuration operation; and
the switch configuration interface includes at least one switch configuration element, each of the at least one switch configuration element corresponding to one type of candidate attribute configuration information.

3. The operation control method according to claim 2, wherein the displaying the switch configuration interface comprises one of:
overlaying the switch configuration interface on the movement control interface;
displaying the switch configuration interface in a surrounding area of the movement control interface, the surrounding area being part of a concentric ring area corresponding to the movement control interface, and a minimum display radius of the surrounding area is greater than or equal to a maximum display radius of the movement control interface; and
displaying the switch configuration interface in an adjacent area of the movement control interface, a distance between a center of the adjacent area and a center of the movement control interface being less than a first threshold.

4. The operation control method according to claim 2, wherein the displaying the switch configuration interface comprises:
displaying candidate skill configuration information corresponding to the virtual character in one of the at least one switch configuration element;
displaying candidate appearance configuration information corresponding to the virtual character in one of the at least one switch configuration element; or
displaying candidate prop configuration information corresponding to the virtual character in one of the at least one switch configuration element.

5. The operation control method according to claim 2, wherein the determining the target attribute configuration information comprises one of:
determining, in response to a click selection operation performed on a target switch configuration element in the switch configuration interface, attribute configuration information corresponding to the target switch configuration element as the target attribute configuration information; and
determining, in response to a touch screen sliding selection operation performed on the target switch configuration element in the switch configuration interface, attribute configuration information corresponding to the target switch configuration element as the target attribute configuration information.

6. The operation control method according to claim 1, further comprising:
determining that the switch configuration operation is obtained based on a press operation performed on the movement control interface being detected and a press duration of the press operation reaching a target duration.

7. The operation control method according to claim 1, further comprising:
determining that the switch configuration operation is obtained based on a sliding operation according to a target track performed in the movement control interface being detected.

8. The operation control method according to claim 1, wherein the displaying the virtual scene comprises:
displaying the virtual character performing a game task based on the target attribute configuration information.

9. An information processing apparatus, comprising:
processing circuitry configured to:
display (i) a virtual scene of a virtual character and (ii) a movement control interface, the movement control interface being configured to receive a movement control operation to control movement of the virtual character in the virtual scene;
display a switch configuration interface in response to a switch configuration operation being performed on the movement control interface, the switch configuration interface being configured to receive a switch attribute configuration control operation for the virtual character;
determine target attribute configuration information for the virtual character in response to the switch attribute configuration control operation being performed on the switch configuration interface; and
control the virtual character based on the target attribute configuration information.

10. The information processing apparatus according to claim 9, wherein
the processing circuitry is configured to display the switch configuration interface in a target area associated with the movement control interface in response to the switch configuration operation; and
the switch configuration interface includes at least one switch configuration element, each of the at least one switch configuration element corresponding to one type of candidate attribute configuration information.

11. The information processing apparatus according to claim 10, wherein the processing circuitry is configured to perform one of:
overlaying the switch configuration interface on the movement control interface;
displaying the switch configuration interface in a surrounding area of the movement control interface, the surrounding area being part of a concentric ring area corresponding to the movement control interface, and a minimum display radius of the surrounding area is greater than or equal to a maximum display radius of the movement control interface; and
displaying the switch configuration interface in an adjacent area of the movement control interface, a distance between a center of the adjacent area and a center of the movement control interface being less than a first threshold.

12. The information processing apparatus according to claim 10, wherein the processing circuitry is configured to perform at least one of:
displaying candidate skill configuration information corresponding to the virtual character in one of the at least one switch configuration element;
displaying candidate appearance configuration information corresponding to the virtual character in one of the at least one switch configuration element; or
displaying candidate prop configuration information corresponding to the virtual character in one of the at least one switch configuration element.

13. The information processing apparatus according to claim 10, wherein the processing circuitry is configured to perform one of:
determining, in response to a click selection operation performed on a target switch configuration element in the switch configuration interface, attribute configuration information corresponding to the target switch configuration element as the target attribute configuration information; and
determining, in response to a touch screen sliding selection operation performed on the target switch configuration element in the switch configuration interface, attribute configuration information corresponding to the target switch configuration element as the target attribute configuration information.

14. The information processing apparatus according to claim 9, wherein the processing circuitry is configured to:
determine that the switch configuration operation is obtained based on a press operation performed on the movement control interface being detected and a press duration of the press operation reaching a target duration.

15. The information processing apparatus according to claim 9, wherein the processing circuitry is configured to:
determine that the switch configuration operation is obtained based on a sliding operation according to a target track performed in the movement control interface being detected.

16. The information processing apparatus according to claim 9, wherein the processing circuitry is configured to:
display the virtual character performing a game task based on the target attribute configuration information.

17. A non-transitory computer-readable storage medium, storing instructions which when executed by a processor cause the processor to perform:
displaying (i) a virtual scene of a virtual character and (ii) a movement control interface, the movement control interface being configured to receive a movement control operation to control movement of the virtual character in the virtual scene;
displaying a switch configuration interface in response to a switch configuration operation being performed on the movement control interface, the switch configuration interface being configured to receive a switch attribute configuration control operation for the virtual character;
determining target attribute configuration information for the virtual character in response to the switch attribute configuration control operation being performed on the switch configuration interface; and
controlling the virtual character based on the target attribute configuration information.

18. The non-transitory computer-readable storage medium according to claim 17, wherein
the displaying the switch configuration interface includes displaying the switch configuration interface in a target area associated with the movement control interface in response to the switch configuration operation; and
the switch configuration interface includes at least one switch configuration element, each of the at least one switch configuration element corresponding to one type of candidate attribute configuration information.

19. The non-transitory computer-readable storage medium according to claim 18, wherein the displaying the switch configuration interface comprises one of:
overlaying the switch configuration interface on the movement control interface;
displaying the switch configuration interface in a surrounding area of the movement control interface, the surrounding area being part of a concentric ring area corresponding to the movement control interface, and a minimum display radius of the surrounding area is greater than or equal to a maximum display radius of the movement control interface; and
displaying the switch configuration interface in an adjacent area of the movement control interface, a distance between a center of the adjacent area and a center of the movement control interface being less than a first threshold.

20. The non-transitory computer-readable storage medium according to claim 18, wherein the displaying the at least one switch configuration element comprises at least one of:
displaying candidate skill configuration information corresponding to the virtual character in the switch configuration interface;
displaying candidate appearance configuration information corresponding to the virtual character in the switch configuration interface; or
displaying candidate prop configuration information corresponding to the virtual character in the switch configuration interface.
